(19) United States
(12) Patent Application Publication
(10) Pub. No.: US 2021/0242522 A1
(43) Pub. Date: Aug. 5, 2021

(54) Hybrid Battery Component and Method for Producing a Hybrid Battery Component

(71) Applicant: Bayerische Motoren Werke Aktiengesellschaft, Muenchen (DE)

(72) Inventor: Ruediger DAUB, Groebenzell (DE)

(21) Appl. No.: 17/049,063

(22) PCT Filed: Apr. 26, 2019
(86) PCT No.: PCT/EP2019/060829

§ 371 Date: Oct. 20, 2020

(30) Foreign Application Priority Data
May 30, 2018 (DE) 10 2018 208 654.0

(51) Int. Cl. H01M 50/159; H01M 50/538; H01M 50/14; H01M 10/04

(52) U.S. Cl. CPC H01M 50/159; H01M 10/04; H01M 50/14; H01M 50/538

(57) ABSTRACT

A hybrid battery component has a plastic housing filled with an electrolyte solution that is open on both sides. An electrode stack is arranged in the plastic housing and has at least one cathode and at least one anode. Two covers are provided made of a metallic material, wherein a first cover completely covers a first opening and a second cover completely covers a second opening of the plastic housing in a fluid-tight manner. The at least one anode is electrically conductively connected to the first cover by a first contact element and the at least one cathode is electrically conductively connected to the second cover by a second contact element.

### BACKGROUND AND SUMMARY OF THE INVENTION

The present invention relates to a hybrid battery component and to a method for producing a hybrid battery component.

Hybrid battery components, for example lithium-ion cells, are currently produced in the form of pouch cells, prismatic cells or cylindrical cells. In the case of pouch cells, the electrodes are welded into a plastic film. Prismatic cells feature a metallic rectangular housing, and cylindrical cells a metallic cylindrical housing.

Pouch cells and cylindrical cells have a disadvantage, in that it is scarcely possible for elements which enhance cell safety to be integrated into the respective housing. In prismatic cells, it is simpler for safety elements of this type to be incorporated into the housing, however, prismatic cells are expensive to produce.

Consequently, an object of the present invention is the provision of a hybrid battery component with a high degree of cell safety, the production of which is cost-effective.

According to the invention, this object is fulfilled by a hybrid battery component, comprising a plastic housing which is open on both sides and filled with an electrolyte solution, an electrode stack arranged in the plastic housing having at least one cathode and at least one anode, and two covers made of a metallic material, wherein a first cover completely covers a first opening, and a second cover completely covers a second opening of the plastic housing in a fluid-tight manner, and wherein the at least one anode is electrically conductively connected to the first cover by way of a first contact element, and the at least one cathode is electrically conductively connected to the second cover by way of a second contact element.

A hybrid battery component which is configured in this manner is particularly cost-effective, particularly on the grounds of the use of a plastic housing. The plastic housing, for example, is an injection-molded component. Various structures and elements can thus be integrated in the plastic housing, with no resulting adverse impact upon production costs. The metal covers can simultaneously be employed as external contact surfaces.

According to one embodiment, a closable filling opening is provided in the plastic housing, in order to permit the filling of the housing with the electrolyte solution. This provides an advantage, in that the filling of the plastic housing with the electrolyte solution can be executed after the fitting of both covers. For example, filling can be executed by means of a nozzle, which can be inserted in the filling opening. The risk of any spillage of the electrolyte solution during filling is minimized accordingly.

The covers are comprised, for example, of aluminum, wherein at least the cover which is arranged on the anode side, on at least one surface which engages in contact with the electrolyte solution, incorporates a protective layer. The protective layer contains, for example, copper, or is comprised of copper. The cover is thus protected against corrosion. However, the covers can also be produced from any other appropriate metals.

The plastic housing preferably incorporates a cooling system, particularly in the form of one or more cooling ducts. These can either be configured directly in the plastic housing during injection-molding, or can be formed thereafter by the machining of the plastic housing.

In order to enhance the cell safety of the battery component, at least one safety element can be incorporated in the plastic housing. For example, a rupture membrane can be arranged in the plastic housing, which fails in response to a predefined pressure. In a particularly preferred form of embodiment, the rupture membrane is configured integrally with the housing. The rupture membrane thus constitutes, for example, a region of the plastic housing in which a housing wall is thinner than the surrounding housing wall, and particularly is sufficiently thin such that the housing wall fails in response to a specific pressure. Alternatively, the rupture membrane can constitute a separate component which is integrated into the plastic housing further to the manufacture of the latter, for example by thermal bonding.

The covers are preferably fastened to the plastic housing by mechanical adhesion. To this end, the surfaces of the covers are at least zonally structured, such that the structured region of the covers incorporates structural elements in the micrometer range and/or in the sub-micrometer range. As a result, the battery component can be produced to a particularly compact design, without the necessity for additional fastening elements which, in turn, impacts favorably upon production costs. The employment of an adhesive can also be omitted.

The object is further fulfilled according to the invention by a method for producing a hybrid battery component, which is configured as per the preceding description, wherein the method comprises the following steps:

a) a plastic housing, which is open on both sides, and two covers of a metallic material are provided,
b) the surface of the covers is at least zonally structured, such that the structured region of the covers incorporates structural elements in the micrometer range and/or in the sub-micrometer range,
c) a first cover is arranged on a first opening of the plastic housing, and is permanently fastened to the plastic housing by the introduction of heat,
d) an electrode stack having at least one cathode and at least one anode is arranged in the plastic housing, and
e) further to step d), the second cover is arranged on the second opening of the plastic housing, and is permanently fastened to the plastic housing by the introduction of heat.

A battery component produced according to this method can be particularly cost-effective.

Between steps c) and e), or after step e), an electrolyte solution can be introduced into the plastic housing. If the plastic housing is filled with the electrolyte solution between steps c) and e), i.e. after the fitting of the first cover, but before the fitting of the second cover, a filling opening in the plastic housing can be omitted. Filling of the plastic housing after step e), i.e. after the fitting of both covers, provides an advantage, in that filling is simpler, and the risk of any spillage of electrolyte solution during assembly is minimized.

The at least one cathode and the at least one anode are respectively electrically conductively connected to the first cover or to the second cover by means of a contact element, wherein the contact elements are connected to the covers by means of thermal bonding. By thermal bonding, a reliable electrically conductive connection between the contact elements and the covers can be constituted such that, in turn, the covers can function as external contact surfaces.

Further advantages and features of the invention proceed from the following description and from the following drawings, to which reference is made.

### BRIEF DESCRIPTION OF THE DRAWINGS

FIG. 1 shows a schematic representation of a hybrid battery component according to an embodiment of the invention.

FIG. 2 shows a schematic exploded representation of a hybrid battery component according to an embodiment of the invention.

### DETAILED DESCRIPTION OF THE DRAWINGS

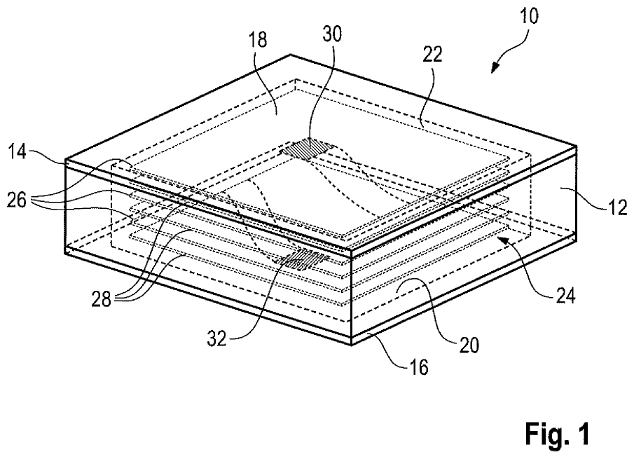

FIG. 1 shows a hybrid battery component 10 having a plastic housing 12 which is open on both sides, and two covers 14, 16 of a metallic material. A first cover 14 covers a first opening 18 of the plastic housing 12, and a second cover 16 covers a second opening 20 of the plastic housing 12 in a fluid-tight manner, such that a closed interior space 22 is constituted. The latter is filled with an electrolyte solution. In the form of embodiment represented, the plastic housing 12 is configured as a rectangular frame. The plastic housing 12 is preferably an injection-molded component, particularly of polypropylene.

The covers 14, 16 are fastened to the plastic housing 12, for example, by mechanical adhesion. However, other options are also conceivable for the fastening of the covers 14, 16 to the plastic housing, for example by adhesive bonding, or by means of additional fastening elements.

The covers 14, 16 can be comprised of aluminum, wherein at least the cover 14 which is arranged on the anode side, on at least one surface which engages in contact with the electrolyte solution, incorporates a protective layer.

The battery component 10 further comprises an electrode stack 24 which is arranged in the plastic housing 12, having a plurality of anodes 26 and a plurality of cathodes 28 which are arranged in an alternating manner.

The anodes 26 are electrically conductively connected to the first cover 14 by way of a first contact element 30, and the cathodes 28 are electrically conductively connected to the second cover 16 by way of a second contact element 32. To this end, each of the electrodes 26, 28, for example, comprises a circumferentially projecting tab, on which the electrodes 26, 28 can be respectively contact connected with the contact element 30, 32. In an overhead view of the electrode stack 24, the tabs of all the anodes 26 and the tabs of all the cathodes 28 are respectively configured in a congruent arrangement. Although, in the interests of simplicity, the tabs are not represented in the figures, contact connection arrangements of this type will be sufficiently familiar to a person skilled in the art.

The contact elements 30, 32 are configured as sheet metal strips, each of which extends along the electrode stack 24 to the covers 14, 16 and is electrically conductively connected to the latter, for example by thermal bonding, particularly by laser welding or ultrasonic welding. As a result, the covers 14, 16 can be used for external contact connection, and the battery component 10 can be used in the manner of a bipolar cell.

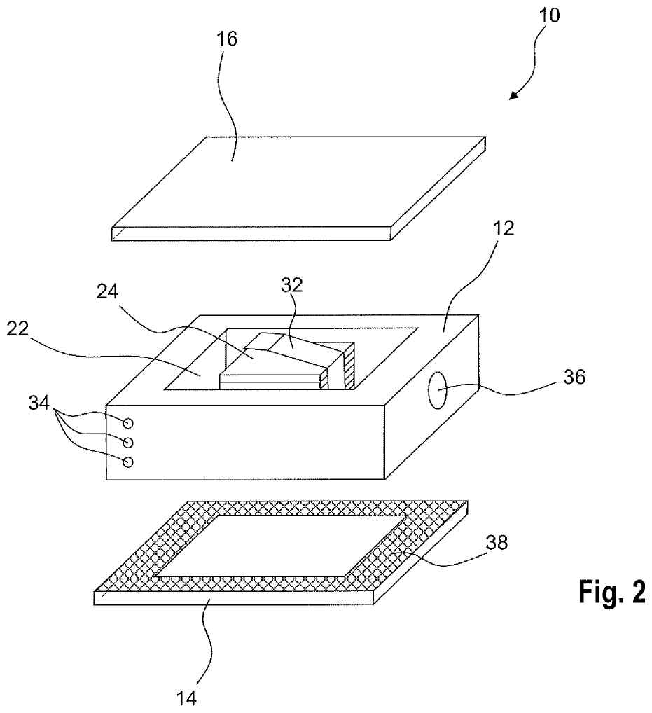

In the plastic housing, cooling ducts 34 and/or safety elements such as, for example, a rupture membrane 36 can additionally be incorporated. The cell safety of the battery component 10 is enhanced accordingly. Although, in FIG. 1, in the interests of simplicity, these elements are not represented, FIG. 2 shows a schematic representation of a plurality of cooling ducts 34, which are oriented along one side of the rectangular plastic housing 12, together with a rupture membrane 36. The rupture membrane 36 is, for example, constituted as a region having a smaller wall thickness than the surrounding wall of the plastic housing 12.

With reference to FIG. 2, a method for producing a hybrid battery component 10 is described schematically hereinafter.

Firstly, a plastic housing 12 which is open on both sides and two covers 14, 16 of a metallic material are provided. The surface of the covers 14, 16 is at least zonally structured, particularly in a region 38 which, after assembly, engages in contact with the plastic housing 12.

The structured region 38 of the covers 14, 16 particularly incorporates structural elements in the micrometer range and/or in the sub-micrometer range. By means of the structural elements, undercuts and/or indentations are constituted in the structured region 38.

Thereafter, a first cover 14 is arranged on a first opening 18 of the plastic housing 12, and is permanently fastened to the plastic housing 12 by the introduction of heat.

The electrode stack 24 is then arranged in the interior space 22 of the plastic housing 12.

After the electrode stack 24 has been arranged in the plastic housing 12, the second cover 16 can be arranged on the second opening 20 of the plastic housing 12, and is permanently fastened to the plastic housing 12 by the introduction of heat.

During the connection of the covers 14, 16 to the plastic housing 12, by the introduction of heat, the plastic housing 12 is partially melted, such that the liquid plastic of the plastic housing 12 is able to flow into the structural elements, particularly into the indentations and undercuts in the covers 14, 16. Once the plastic has cooled and hardened, the plastic material is anchored in the covers 14, 16, and thus maintains the covers 14, 16 securely on the plastic housing 12. This process is also described as mechanical adhesion.

After the fastening of the first cover 14 and prior to the fastening of the second cover 16 onto the plastic housing 12, an electrolyte solution which, in the interests of simplicity, is not represented, can be introduced into the plastic housing 12. Alternatively, the electrolyte solution can be introduced into the plastic housing 12 via a filling opening, after the fastening of both covers 14, 16.

The anodes 26 and the cathodes 28 of the electrode stack 24 are respectively electrically conductively connected to the first cover 14 or to the second cover by means of the contact elements 30, 32, wherein the contact elements 30, 32 are connected to the covers 14, 16 by thermal bonding, particularly by laser or ultrasonic welding.

According to one form of embodiment, after the fastening of the first cover 14 to the plastic housing 12, the electrode stack 24 can be fastened to the cover 14 by means of the first contact element 30. As a result, the electrode stack 24 is secured in a desired position, and is no longer susceptible to slipping, once the second cover 16 has been fastened. It is additionally possible for an assembly aid to be arranged in the plastic housing 12, which retains the electrode stack 24 in a desired position, until the latter is fastened to the first cover 14. Alternatively, the electrode stack 24 can also be fastened to the cover 14, prior to the fastening of the first cover 14 to the plastic housing 12. The electrode stack 24 is then introduced into the housing 12 upon the fitting of the cover 14 to the plastic housing 12.

1.-9. (canceled)

10. A hybrid battery component, comprising:
a plastic housing which is open on both sides and filled with an electrolyte solution;
an electrode stack arranged in the plastic housing having at least one cathode and at least one anode; and
two covers made of a metallic material, wherein
a first cover completely covers a first opening, and a second cover completely covers a second opening of the plastic housing in a fluid-tight manner, and
the at least one anode is electrically conductively connected to the first cover by a first contact element, and the at least one cathode is electrically conductively connected to the second cover by a second contact element.

11. The hybrid battery component according to claim 10, wherein
a closable filling opening is provided in the plastic housing in order to permit filling of the housing with the electrolyte solution.

12. The hybrid battery component according to claim 10, wherein
the two covers are comprised of aluminum, wherein at least the cover which is arranged on the anode side, on at least one surface which engages in contact with the electrolyte solution, incorporates a protective layer.

13. The hybrid battery component according to claim 10, wherein
a cooling system is incorporated in the plastic housing.

14. The hybrid battery component according to claim 10, wherein
at least one safety element is incorporated in the plastic housing.

15. The hybrid battery component according to claim 10, wherein
the two covers are fastened to the plastic housing by mechanical adhesion.

16. A method for producing a hybrid battery component, the method comprising the steps of:
a) providing a plastic housing, which is open on both sides, and two covers of a metallic material, wherein a surface of the covers is at least zonally structured, such that a structured region of the covers incorporates structural elements in a micrometer range and/or in a sub-micrometer range;
b) arranging a first cover on a first opening of the plastic housing, and permanently fastening the first cover to the plastic housing by introduction of heat;
c) arranging an electrode stack having at least one cathode and at least one anode in the plastic housing; and
d) subsequently to step c), arranging the second cover on a second opening of the plastic housing, and permanently fastening the second cover to the plastic housing by introduction of heat.

17. The method according to claim 16, wherein
between steps b) and d), or after step d), an electrolyte solution is introduced into the plastic housing.

18. The method according to claim 16, wherein the at least one cathode and the at least one anode are respectively electrically conductively connected to the first cover or to the second cover by a contact element, wherein the contact elements are connected to the covers by thermal bonding.
